(19) United States
(12) Patent Application Publication
(10) Pub. No.: US 2017/0116933 A1
(43) Pub. Date: Apr. 27, 2017

(54) Driving Circuit and Method for Dynamically Switching Frame Rates of Display Panel

(71) Applicant: Shenzhen China Star Optoelectronics Technology Co. , Ltd., Shenzhen City (CN)

(72) Inventor: Xiangyang Xu, Shenzhen City (CN)

(73) Assignee: Shenzhen China Star Optoelectronics Technology Co. , Ltd., Shenzhen City, Guangdong (CN)

(21) Appl. No.: 14/778,614

(22) PCT Filed: May 22, 2015
(86) PCT No.: PCT/CN2015/079536

§ 371 Date: Sep. 21, 2015

(30) Foreign Application Priority Data
May 11, 2015 (CN) 201510238095.5

(51) Int. Cl. G09G 3/36

(52) U.S. Cl. CPC G09G 3/3607; G09G 2340/0435; G09G 2370/14; G09G 2310/08; G09G 2320/0693; G09G 2320/106; G09G 2310/027; G09G 2330/021

(57) ABSTRACT

A driving circuit for dynamically switching frame rates of a display panel, includes: an interface module (1), a power supplying module (2), a timing controlling module (3), a frame rate determining module (4), a gamma voltage module (5), and a source driving module (6). The frame rate determining module (4) determines a speed of a motion object and generates a high or low frame rate signal to the source driving module (6) based on the speed of the motion object. The frame rate increases in response to high speed of the motion object, while the frame rate decreases in response to low speed of the motion object. Therefore, the present invention not only smoothes dynamic image display but also lowers the logic power consumption of the display panel. The present invention achieves both goals of smooth dynamic image display and ecological ideals.

### BACKGROUND OF THE INVENTION

1. Field of the Invention

The present invention relates to display technology field, more particularly to a driving circuit and a method of dynamically switching frame rates of a display panel.

2. Description of the Prior Art

Nowadays, liquid crystal displays (LCDs) which are flat displays have advantages over high resolution, low power consumption, efficient utilization of space, and wide application scope, are widely used in various consumer electronic products such as mobile phones, personal digital assistants (PDAs), digital cameras, notebook computers, and laptop computers. The liquid crystal displays have gradually become a mainstream product in the display. The screen of the flat display has become a main interactive equipment.

Every pixel of a liquid crystal display panel is electrically connected to a thin film transistor (TFT), whose a gate is connected to a scan line, a source connected to a data line, and a drain connected to a pixel electrode. The data line is electrically connected to a source driving module which drives the data line.

As display technology improves, display panels are demanded of higher resolution, greater gamut, and higher frame rate. Higher frame rate is for smoother dynamic image display. Nowadays, common display frame rate has been increased gradually from 60 Hz to 120 Hz, or even 240 Hz. The 60 Hz frame rate means that a single frame is shown every 1/60 second. The 120 HZ frame rate means that a single frame is shown every 1/120 second. And the 240 Hz frame rate means that a single frame is shown every 1/240 second. That is, higher frame rate means more frames to be displayed in a given amount of time as well as smoother display results of motion objects. In conclusion, display panels with higher frame rate have higher quality in dynamic image display.

However, in a conventional display, frame rate is kept constant, so problems ensue. The 60 Hz frame rate does not qualify for dynamic image display. In contrast, though high frame rate does, unnecessary power consumption of display panels occurs for still or slow object images, which is against low-carbon ecological ideals.

### SUMMARY OF THE INVENTION

The present invention provides a driver circuit for dynamically switching frame rates of a display panel, which produces smooth dynamic image display, lowers logic power consumption of display panels, and thus is for ecological ideals.

The present invention also provides a method for dynamically switching frame rates of a display panel, which produces smooth dynamic image display, lowers logic power consumption of display panels, and thus is for ecological ideals.

According to the present invention, a driving circuit for dynamically switching frame rates of a display panel, comprises: an interface module, a power supplying module, a timing controlling module, a frame rate determining module, a gamma voltage module, and a source driving module;

the interface module is electrically connected with the power supplying module and the timing controlling module; the power supplying module is electrically connected with the interface module, the timing controlling module, the frame rate determining module, and the gamma voltage module; the timing controlling module is electrically connected with the interface module, the power supplying module, the frame rate determining module, and the source driving module; the frame rate determining module is electrically connected with the power supplying module, the timing controlling module, and the source driving module; the gamma voltage module is electrically connected with the power supplying module and the source driving module; the source driving module is electrically connected with the timing controlling module, the frame rate determining module, and the gamma voltage module;

the interface module transmits digital signal and supply voltage signal to the timing controlling module and power supply module, respectively;

the power supply module supplies steady voltage to the timing controlling module, the frame rate determining module, and the gamma voltage module based on the supply voltage signal from the interface module;

the timing controlling module converts the digital signal into display data signal which is indentified by the source driving module and the frame rate determining module;

the frame rate determining module determines a speed of a motion object between two consecutive frames and for generating a frame rate signal to the source driving module to adjust the frame rate based on the speed of the motion object;

the gamma voltage module calibrates the voltage supplied by the power supplying module into gamma voltage; and

source driving module drives a display panel according to the display data signal from the timing controlling module and the frame rate signal from the frame rate determining module.

Furthermore, the digital signal fed to the timing controlling module from the interface module is LVDS signal or e-DP signal.

Furthermore, the timing controlling module converts the LVDS signal or the e-DP signal into Mini-LVDS signal.

Furthermore, the frame rate determining module determines the speed of the motion object based on similarity degree between two consecutive frames.

Furthermore, upon a condition that the speed of the motion object between two consecutive frames is fast, the frame rate determining module supplies high frame rate signal to the source driving module; upon a condition that the speed of the motion object between two consecutive frames is slow, the frame rate determining module supplies low frame rate signal to the source driving module.

According to the present invention, a method of dynamically switching frame rates of a display panel comprises:

Step 1: providing a driving circuit for dynamically switching frame rates of a display panel, comprising an interface module, a power supplying module, a timing controlling module, a frame rate determining module, a gamma voltage module, and a source driving module,

wherein the interface module is electrically connected with the power supplying module and the timing controlling module; the power supplying module is electrically connected with the interface module, the timing controlling module, the frame rate determining module, and the gamma voltage module; the timing controlling module is electrically connected with the interface module, the power supplying module, the frame rate determining module, and the source driving module; the frame rate determining module is electrically connected with the power supplying module, the timing controlling module, and the source driving module; the gamma voltage module is electrically connected with the power supplying module and the source driving module; the source driving module is electrically connected with the timing controlling module, the frame rate determining module, and the gamma voltage module;

Step 2: using the interface module to transmit the digital signal and supply voltage signal to the timing controlling module and the power supply module, respectively;

Step 3: using the power supply module to supply steady voltage to the timing controlling module, the frame rate determining module, and the gamma voltage module based on the supply voltage signal,

wherein the timing controlling module converts the digital signal into display data signal which is indentified by the source driving module and the frame rate determining module, and the timing controlling module transmits the display data signal to the source driving module and the frame rate determining module;

Step 4: using the frame rate determining module to determine a speed of a motion object between two consecutive frames, and to generate a frame rate signal to the source driving module to adjust the frame rate based on the speed of the motion object; and

Step 5: using the source driving module to calculate grey level voltage and to output display data signal based on the display data signal from the timing controlling module and the frame rate signal from the frame rate determining module, so as to drive a display panel.

Furthermore, in the step 2, the digital signal fed to the timing controlling module from the interface module is LVDS signal or e-DP signal.

Furthermore, in the step 3, the timing controlling module converts the LVDS signal or the e-DP signal into Mini-LVDS signal.

Furthermore, in the step 4, the frame rate determining module determines the speed of the motion object based on similarity degree between two consecutive frames.

Furthermore, the similarity degree between two consecutive frames is determined by comparing a number of pixels with different brightness in two consecutive frames, the two consecutive frames are transmitted from the timing controlling module.

Furthermore, in the step 4, upon a condition that the speed of the motion object between two consecutive frames is fast, the frame rate determining module supplies high frame rate signal to the source driving module; upon a condition that the speed of the motion object between two consecutive frames is slow, the frame rate determining module supplies low frame rate signal to the source driving module.

According to the present invention, a method of dynamically switching frame rates of a display panel comprises:

Step 1: providing a driving circuit for dynamically switching frame rates of a display panel, comprising an interface module, a power supplying module, a timing controlling module, a frame rate determining module, a gamma voltage module, and a source driving module,

wherein the interface module is electrically connected with the power supplying module and the timing controlling module; the power supplying module is electrically connected with the interface module, the timing controlling module, the frame rate determining module, and the gamma voltage module; the timing controlling module is electrically connected with the interface module, the power supplying module, the frame rate determining module, and the source driving module; the frame rate determining module is electrically connected with the power supplying module, the timing controlling module, and the source driving module; the gamma voltage module is electrically connected with the power supplying module and the source driving module; the source driving module is electrically connected with the timing controlling module, the frame rate determining module, and the gamma voltage module;

Step 2: using the interface module to transmit the digital signal and supply voltage signal to the timing controlling module and the power supply module, respectively;

Step 3: using the power supply module to supply steady voltage to the timing controlling module, the frame rate determining module, and the gamma voltage module based on the supply voltage signal,

wherein the timing controlling module converts the digital signal into display data signal which is indentified by the source driving module and the frame rate determining module, and the timing controlling module transmits the display data signal to the source driving module and the frame rate determining module;

Step 4: using the frame rate determining module to determine a speed of a motion object between two consecutive frames, and to generate a frame rate signal to the source driving module to adjust the frame rate based on the speed of the motion object; and

Step 5: using the source driving module to calculate grey level voltage and to output display data signal based on the display data signal from the timing controlling module and the frame rate signal from the frame rate determining module, so as to drive a display panel, wherein in the step 2, the digital signal fed to the timing controlling module from the interface module is LVDS signal or e-DP signal,

wherein in the step 3, the timing controlling module converts the LVDS signal or the e-DP signal into Mini-LVDS signal,

and wherein in the step 4, the frame rate determining module determines the speed of the motion object based on similarity degree between two consecutive frames.

The present invention provides a driver circuit for dynamically switching frame rates of display panel, in which a frame rate determining module is set to tell the speed of a motion object in two consecutive frames in order to decide whether a high frame rate signal or a low frame rate signal is sent to a source driving module. When the speed is determined to be high, a high frame rate signal is sent, leading to smooth dynamic image display. When the speed is determined to be low, a low frame rate signal is sent, lowering the logic power consumption of display panels, achieving low-carbon emission. The present invention also provides a method for dynamically switching frame rates of a display panel by adding a step of determining frame rate before the source driving module drives its display panel, achieving both goals of smooth dynamic image display and ecological ideals.

These and other features, aspects and advantages of the present disclosure will become understood with reference to the following description, appended claims and accompanying figures.

### BRIEF DESCRIPTION OF THE DRAWINGS

The accompanying drawings are included to provide a further understanding of the invention, and are incorporated in and constitute a part of this specification.

FIG. 1 shows a circuit diagram of a driving circuit of dynamically switching frame rates of a display panel according to a preferred embodiment of the present invention.

FIG. 2 illustrates a flowchart of a method of dynamically switching frame rates of a display panel according to a preferred embodiment of the present invention.

### DETAILED DESCRIPTION OF THE PREFERRED EMBODIMENTS

The drawings illustrate embodiments of the invention and, together with the description, serve to explain the principles of the invention.

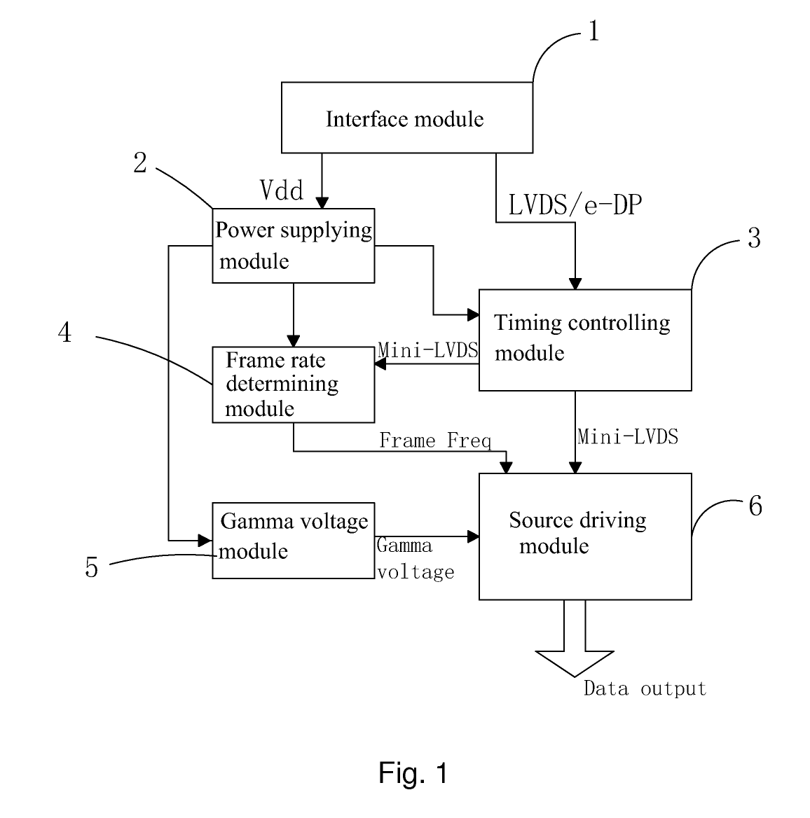

Please refer to FIG. 1. A driving circuit for dynamically switching frame rates of a display panel, comprises an interface module 1, a power supplying module 2, a timing controlling module 3, a frame rate determining module 4, a gamma voltage module 5 and a source driving module 6.

The connections among the modules are introduced as follows: the interface module 1 is electrically connected with the power supplying module 2 and the timing controlling module 3; the power supplying module 2 is electrically connected with the interface module 1, the timing controlling module 3, the frame rate determining module 4, and the gamma voltage module 5; the timing controlling module 3 is electrically connected with the interface module 1, the power supplying module 2, the frame rate determining module 4, and the source driving module 6; the frame rate determining module 4 is electrically connected with the power supplying module 2, the timing controlling module 3, and the source driving module 6; the gamma voltage module 5 is electrically connected with the power supplying module 2 and the source driving module 6; the source driving module 6 is electrically connected with the timing controlling module 3, the frame rate determining module 4, and the gamma voltage module 5.

The interface module 1 is used for transmitting the digital signal and supply voltage signal Vdd to the timing controlling module 3 and power supply module 2, respectively. Specifically, the digital signal fed to the timing controlling module 3 from the interface module 1 is LVDS signal or e-DP signal. The interface module 1 transmits the supply voltage signal Vdd to the power supply module 2.

The power supply module 2 supplies steady voltage to the timing controlling module 3, the frame rate determining module 4, and the gamma voltage module 5 based on the supply voltage signal Vdd from the interface module 1. Specifically, the power supplying module 2 comprises a boosting unit, a bucking unit, and a rectifying unit. The steady voltages supplied to the modules are converted from supply voltage signal Vdd via the boosting unit, the bucking unit, and the rectifying unit.

The timing controlling module 3 is used for converting the digital signal into display data signal which is indentified by the source driving module 6 and the frame rate determining module 4. Specifically, the LVDS signal or e-DP signal is converted into Mini-LVDS signal by the timing controlling module 3.

The frame rate determining module 4 is used for determining a speed of a motion object between two consecutive frames and for generating a frame rate signal Fram Freq to the source driving module 6 to adjust the frame rate based on the speed of the motion object. Specifically, the frame rate determining module 4 determines the speed of the motion object based on similarity degree between two consecutive frames. Furthermore, the similarity degree between two consecutive frames and the motion object in the two consecutive frames are determined by detecting Mini-LVDS signals to compare a number of pixels with different brightness in two consecutive frames. Accordingly, the speed of the motion object is calculated based on the positions of pixels with different brightness in two consecutive frames. Upon a condition that the speed of the motion object between two consecutive frames is fast, the frame rate determining module 4 supplies high frame rate signal to the source driving module 6 to increase the frame rate, thereby smoothly displaying the dynamic images. Upon a condition that the speed of the motion object between two consecutive frames is slow, the frame rate determining module 4 supplies low frame rate signal to the source driving module 6 to decrease the frame rate, thereby reducing logic power consumption to realize low-carbon ecological ideals. Preferably, a frequency of the high frame rate signal is 120 Hz or 240 Hz, while a frequency of the low frame rate signal is 60 Hz.

The gamma voltage module 5 is used for calibrating the voltage supplied by the power supplying module 2 into gamma voltage, and for transmitting the gamma to the source driving module 6.

The source driving module 6 is used for calculating grey level voltage and outputting display data signal Data based on the display data signal from the timing controlling module 3 and the frame rate signal from the frame rate determining module 4, so as to drive a display panel.

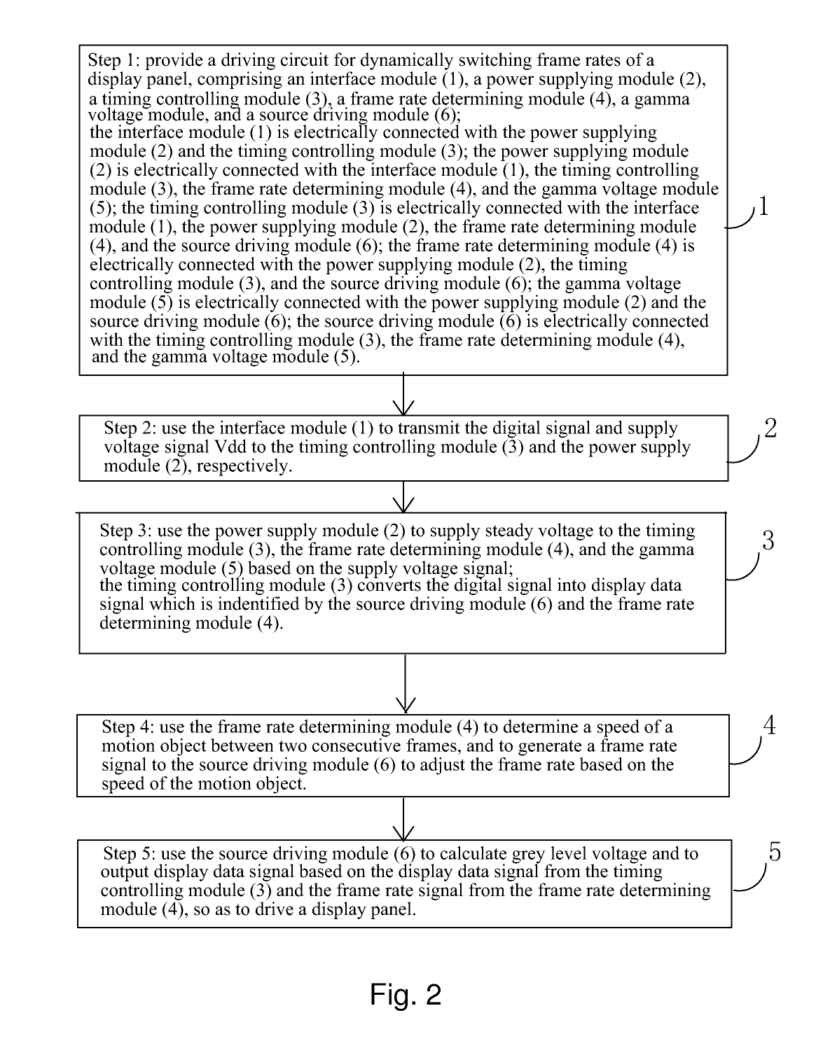

Please refer to FIG. 2 in conjunction to FIG. 1. The present invention also proposes a method of dynamically switching frame rates of a display panel. The method comprises:

Step 1: provide a driving circuit for dynamically switching frame rates of a display panel, comprising an interface module 1, a power supplying module 2, a timing controlling module 3, a frame rate determining module 4, a gamma voltage module 5, and a source driving module 6.

The interface module 1 is electrically connected with the power supplying module 2 and the timing controlling module 3; the power supplying module 2 is electrically connected with the interface module 1, the timing controlling module 3, the frame rate determining module 4, and the gamma voltage module 5; the timing controlling module 3 is electrically connected with the interface module 1, the power supplying module 2, the frame rate determining module 4, and the source driving module 6; the frame rate determining module 4 is electrically connected with the power supplying module 2, the timing controlling module 3, and the source driving module 6; the gamma voltage module 5 is electrically connected with the power supplying module 2 and the source driving module 6; the source driving module 6 is electrically connected with the timing controlling module 3, the frame rate determining module 4, and the gamma voltage module 5.

Step 2: use the interface module 1 to transmit the digital signal and supply voltage signal P Vdd to the timing controlling module 3 and the power supply module 2, respectively.

Specifically, the digital signal fed to the timing controlling module 3 from the interface module 1 is LVDS signal or e-DP signal.

Step 3: use the power supply module 2 to supply steady voltage to the timing controlling module 3, the frame rate determining module 4, and the gamma voltage module 5 based on the supply voltage signal Vdd.

The timing controlling module 3 converts the digital signal into display data signal which is indentified by the source driving module 6 and the frame rate determining module 4.

Specifically, the power supplying module 2 comprises a boosting unit, a bucking unit, and a rectifying unit. The steady voltages supplied to the modules are converted from supply voltage signal Vdd via the boosting unit, the bucking unit, and the rectifying unit. The LVDS signal or e-DP signal is converted into Mini-LVDS signal by the timing controlling module 3.

Step 4: use the frame rate determining module 4 to determine a speed of a motion object between two consecutive frames, and to generate a frame rate signal Fram Freq to the source driving module 6 to adjust the frame rate based on the speed of the motion object.

Specifically, the frame rate determining module 4 determines the speed of the motion object based on similarity degree between two consecutive frames. Furthermore, the similarity degree between two consecutive frames and the motion object in the two consecutive frames are determined by detecting Mini-LVDS signals to compare the number of pixels with different brightness in two consecutive frames sent from the timing controlling module 3. Accordingly, the speed of the motion object is calculated based on the positions of different brightness pixels between two consecutive frames. Upon a condition that the speed of the motion object between two consecutive frames is fast, the frame rate determining module 4 supplies high frame rate signal to the source driving module 6 to increase the frame rate, thereby smoothly displaying the dynamic images. Upon a condition that the speed of the motion object between two consecutive frames is slow, the frame rate determining module 4 supplies low frame rate signal to the source driving module 6 to decrease the frame rate, thereby reducing logic power consumption to realize low-carbon ecological ideals. Preferably, a frequency of the high frame rate signal is 120 Hz or 240 Hz, while a frequency of the low frame rate signal is 60 Hz.

Preferably, a frequency of the high frame rate signal is 120 Hz or 240 Hz, while a frequency of the low frame rate signal is 60 Hz.

Step 5: use the source driving module 6 to calculate grey level voltage and to output display data signal Data based on the display data signal from the timing controlling module 3 and the frame rate signal from the frame rate determining module 4, so as to drive a display panel.

In sum, the present invention provides a driver circuit for dynamically switching frame rates of display panel, in which a frame rate determining module is set to tell the speed of a motion object in two consecutive frames in order to decide whether a high frame rate signal or a low frame rate signal is sent to a source driving module. When the speed is determined to be high, a high frame rate signal is sent, leading to smooth dynamic image display. When the speed is determined to be low, a low frame rate signal is sent, lowering the logic power consumption of display panels, achieving low-carbon emission. The present invention also provides a method for dynamically switching frame rates of a display panel by adding a step of determining frame rate before the source driving module drives its display panel, achieving both goals of smooth dynamic image display and low-carbon ecological ideals.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A driving circuit for dynamically switching frame rates of a display panel, comprising an interface module, a power supplying module, a timing controlling module, a frame rate determining module, a gamma voltage module, and a source driving module;
the interface module is electrically connected with the power supplying module and the timing controlling module; the power supplying module is electrically connected with the interface module, the timing controlling module, the frame rate determining module, and the gamma voltage module; the timing controlling module is electrically connected with the interface module, the power supplying module, the frame rate determining module, and the source driving module; the frame rate determining module is electrically connected with the power supplying module, the timing controlling module, and the source driving module; the gamma voltage module is electrically connected with the power supplying module and the source driving module; the source driving module is electrically connected with the timing controlling module, the frame rate determining module, and the gamma voltage module;
the interface module transmits digital signal and supply voltage signal to the timing controlling module and the power supply module, respectively;
the power supply module supplies steady voltage to the timing controlling module, the frame rate determining module, and the gamma voltage module based on the supply voltage signal from the interface module;
the timing controlling module converts the digital signal into display data signal which is indentified by the source driving module and the frame rate determining module;
the frame rate determining module determines a speed of a motion object between two consecutive frames and for generating a frame rate signal to the source driving module to adjust the frame rate based on the speed of the motion object;
the gamma voltage module calibrates the voltage supplied by the power supplying module into gamma voltage; and
the source driving module drives a display panel according to the display data signal from the timing controlling module and the frame rate signal from the frame rate determining module.

2. The driving circuit of claim 1, wherein the digital signal fed to the timing controlling module from the interface module is LVDS signal or e-DP signal.

3. The driving circuit of claim 2, wherein the timing controlling module converts the LVDS signal or the e-DP signal into Mini-LVDS signal.

4. The driving circuit of claim 1, wherein the frame rate determining module determines the speed of the motion object based on the similarity degree between two consecutive frames.

5. The driving circuit of claim 4, wherein the similarity degree between two consecutive frames is determined by comparing a number of pixels with different brightness in two consecutive frames, the two consecutive frames are transmitted from the timing controlling module.

6. The driving circuit of claim 1, wherein upon a condition that the speed of the motion object between two consecutive frames is fast, the frame rate determining module supplies high frame rate signal to the source driving module; upon a condition that the speed of the motion object between two consecutive frames is slow, the frame rate determining module supplies low frame rate signal to the source driving module.

7. The driving circuit of claim 6, wherein a frequency of the high frame rate signal is 120 Hz or 240 Hz, while a frequency of the low frame rate signal is 60 Hz.

8. A method of dynamically switching frame rates of a display panel comprising:
Step 1: providing a driving circuit for dynamically switching frame rates of a display panel, comprising an interface module, a power supplying module, a timing controlling module, a frame rate determining module, a gamma voltage module, and a source driving module,
wherein the interface module is electrically connected with the power supplying module and the timing controlling module; the power supplying module is electrically connected with the interface module, the timing controlling module, the frame rate determining module, and the gamma voltage module; the timing controlling module is electrically connected with the interface module, the power supplying module, the frame rate determining module, and the source driving module; the frame rate determining module is electrically connected with the power supplying module, the timing controlling module, and the source driving module; the gamma voltage module is electrically connected with the power supplying module and the source driving module; the source driving module is electrically connected with the timing controlling module, the frame rate determining module, and the gamma voltage module;
Step 2: using the interface module to transmit the digital signal and supply voltage signal to the timing controlling module and the power supply module, respectively;
Step 3: using the power supply module to supply steady voltage to the timing controlling module, the frame rate determining module, and the gamma voltage module based on the supply voltage signal,
wherein the timing controlling module converts the digital signal into display data signal which is indentified by the source driving module and the frame rate determining module, and the timing controlling module transmits the display data signal to the source driving module and the frame rate determining module;
Step 4: using the frame rate determining module to determine a speed of a motion object between two consecutive frames, and to generate a frame rate signal to the source driving module to adjust the frame rate based on the speed of the motion object; and
Step 5: using the source driving module to calculate grey level voltage and to output display data signal based on the display data signal from the timing controlling module and the frame rate signal from the frame rate determining module, so as to drive a display panel.

9. The method of claim 8, wherein in the step 2, the digital signal fed to the timing controlling module from the interface module is LVDS signal or e-DP signal.

10. The method of claim 9, wherein in the step 3, the timing controlling module converts the LVDS signal or the e-DP signal into Mini-LVDS signal.

11. The method of claim 8, wherein in the step 4, the frame rate determining module determines the speed of the motion object based on the similarity degree between two consecutive frames.

12. The method of claim 11, wherein the similarity degree between two consecutive frames is determined by comparing a number of pixels with different brightness in two consecutive frames, the two consecutive frames are transmitted from the timing controlling module.

13. The method of claim 8, wherein in the step 4, upon a condition that the speed of the motion object between two consecutive frames is fast, the frame rate determining module supplies high frame rate signal to the source driving module; upon a condition that the speed of the motion object between two consecutive frames is slow, the frame rate determining module supplies low frame rate signal to the source driving module.

14. A method of dynamically switching frame rates of a display panel comprising:
Step 1: providing a driving circuit for dynamically switching frame rates of a display panel, comprising an interface module, a power supplying module, a timing controlling module, a frame rate determining module, a gamma voltage module, and a source driving module,
wherein the interface module is electrically connected with the power supplying module and the timing controlling module; the power supplying module is electrically connected with the interface module, the timing controlling module, the frame rate determining module, and the gamma voltage module; the timing controlling module is electrically connected with the interface module, the power supplying module, the frame rate determining module, and the source driving module; the frame rate determining module is electrically connected with the power supplying module, the timing controlling module, and the source driving module; the gamma voltage module is electrically connected with the power supplying module and the source driving module; the source driving module is electrically connected with the timing controlling module, the frame rate determining module, and the gamma voltage module;
Step 2: using the interface module to transmit the digital signal and supply voltage signal to the timing controlling module and the power supply module, respectively;
Step 3: using the power supply module to supply steady voltage to the timing controlling module, the frame rate determining module, and the gamma voltage module based on the supply voltage signal,
wherein the timing controlling module converts the digital signal into display data signal which is indentified by the source driving module and the frame rate determining module, and the timing controlling module transmits the display data signal to the source driving module and the frame rate determining module;
Step 4: using the frame rate determining module to determine a speed of a motion object between two consecutive frames, and to generate a frame rate signal to the source driving module to adjust the frame rate based on the speed of the motion object; and
Step 5: using the source driving module to calculate grey level voltage and to output display data signal based on the display data signal from the timing controlling module and the frame rate signal from the frame rate determining module, so as to drive a display panel,
wherein in the step 2, the digital signal fed to the timing controlling module from the interface module is LVDS signal or e-DP signal,
wherein in the step 3, the timing controlling module converts the LVDS signal or the e-DP signal into Mini-LVDS signal,
and wherein in the step 4, the frame rate determining module determines the speed of the motion object based on similarity degree between two consecutive frames.

15. The method of claim 14, wherein in the step 4, upon a condition that the speed of the motion object between two consecutive frames is fast, the frame rate determining module supplies high frame rate signal to the source driving module; upon a condition that the speed of the motion object between two consecutive frames is slow, the frame rate determining module supplies low frame rate signal to the source driving module.
